(19) United States
(12) Patent Application Publication
(10) Pub. No.: US 2009/0043649 A1
(43) Pub. Date: Feb. 12, 2009

(54) Content Item Pricing

(75) Inventors: Daniel M. Wright, Millbrae, CA (US); Diane L. Tang, Portola Valley, CA (US); Nicholas C. Fox, Foster City, CA (US); Ilia Mirkin, San Francisco, CA (US); Clayton W. Bavor, JR., San Francisco, CA (US); Gregory Joseph Badros, Palo Alto, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/836,960

(22) Filed: Aug. 10, 2007

Related U.S. Application Data
(60) Provisional application No. 60/954,722, filed on Aug. 8, 2007.

(51) Int. Cl. G06Q 30/00

(52) U.S. Cl. 705/14

(57) ABSTRACT

A threshold measure is determined for an advertisement based on one or more parameters associated with the advertisement. A determination is made as to whether the threshold measure exceeds a filter threshold. The advertisement is promoted if the threshold measure exceeds the filter threshold, and an actual cost-per-click for the advertisement based on the one or more parameters and the filter threshold if the advertisement is promoted.

### CROSS-REFERENCE TO RELATED APPLICATION

This application claims priority to U.S. Provisional Patent Application Ser. No. 60/954,722 filed Aug. 8, 2007, and entitled “CONTENT ITEM PRICING,” the contents of which are incorporated herein by reference.

### BACKGROUND

This disclosure relates to information retrieval.

Content items, e.g., advertisements, can be identified by a search engine in response to a query. The query can include one or more search terms, and the search engine can identify and rank the content items based on, for example, the search terms, e.g., keywords, in the query and one or more parameters associated with the content item.

In some online advertising systems, advertisers pay for their advertisements on a cost-per-click basis. Advertisers can select the maximum cost-per-click the advertisers are willing to pay for each click of an advertisement. The cost-per-click charged for an identified advertisement can be calculated based on the other advertisements rated or positioned below the current advertisements and a click-through rate for the current advertisement in an auction process.

Determining an actual cost-per-click for the advertisements that is not only based on the other advertisements (e.g., below the current advertisement) can result in an optimization of advertising revenue. Some advertising systems charge the maximum cost-per-click. However, other optimization processes can also be used to select a subset of advertisements to be displayed and the actual cost-per-click to be charged.

### SUMMARY

Disclosed herein are systems, methods and computer program products for filtering and pricing content items. In one implementation, a threshold measure is determined for an advertisement based on one or more parameters associated with the advertisement. A determination is made as to whether the threshold measure exceeds a filter threshold. The advertisement is promoted if the threshold measure exceeds the filter threshold, and an actual cost-per-click for the advertisement is based on the one or more parameters and the filter threshold if the advertisement is promoted.

In another implementation, one or more advertisements are received. The advertisements can each be associated with one or more parameters. Threshold measures are determined for each advertisement based on the one or more parameters, and the advertisements are filtered based on the threshold measures and a filter threshold.

In another implementation, a threshold measure is determined for an advertisement based on one or more parameters associated with the advertisement. A determination is made as to whether the threshold measure exceeds a filter threshold, and an actual cost-per-click is calculated for the advertisement if the threshold measure exceeds the filter threshold according to the one or more parameters and the filter threshold.

In another implementation, a first score associated with an advertisement is calculated. A determination is made as to whether an auction cost-per-click associated with the advertisement exceeds a reserve cost-per-click associated with the advertisement if the first score exceeds a threshold. An advertiser associated with the advertisement is charged the auction cost-per-click if the first score exceeds the threshold and the auction cost-per-click exceeds the reserve cost-per-click. The advertiser is charged the reserve cost-per-click if the first score exceeds the threshold and the auction cost-per-click does not exceed the reserve cost-per-click.

In another implementation, a system includes a threshold engine that determines a threshold measure for an advertisement based on one or more parameters associated with the advertisement, and determines if the threshold measure exceeds a filter threshold, and a pricing engine that calculates an actual cost-per-click for the advertisement if the threshold measure exceeds the filter threshold according to the one or more parameters.

### BRIEF DESCRIPTION OF THE DRAWINGS

FIG. 1 is a block diagram of an example implementation of an online advertising system.

FIG. 2 is a block diagram of an example content threshold system.

FIG. 3 is an example filtering and ranking table.

FIG. 4 is a flow diagram of an example process for filtering and pricing an advertisement.

FIG. 5 is flow diagram of an example process for determining an actual cost-per-click for an advertisement.

FIG. 6 is a flow diagram for another example process for filtering and pricing an advertisement.

FIG. 7 is a flow diagram of another example process for to filtering and pricing an advertisement.

FIG. 8 is a schematic diagram of an example computer system that can be utilized to implement the systems and methods described herein.

### DETAILED DESCRIPTION

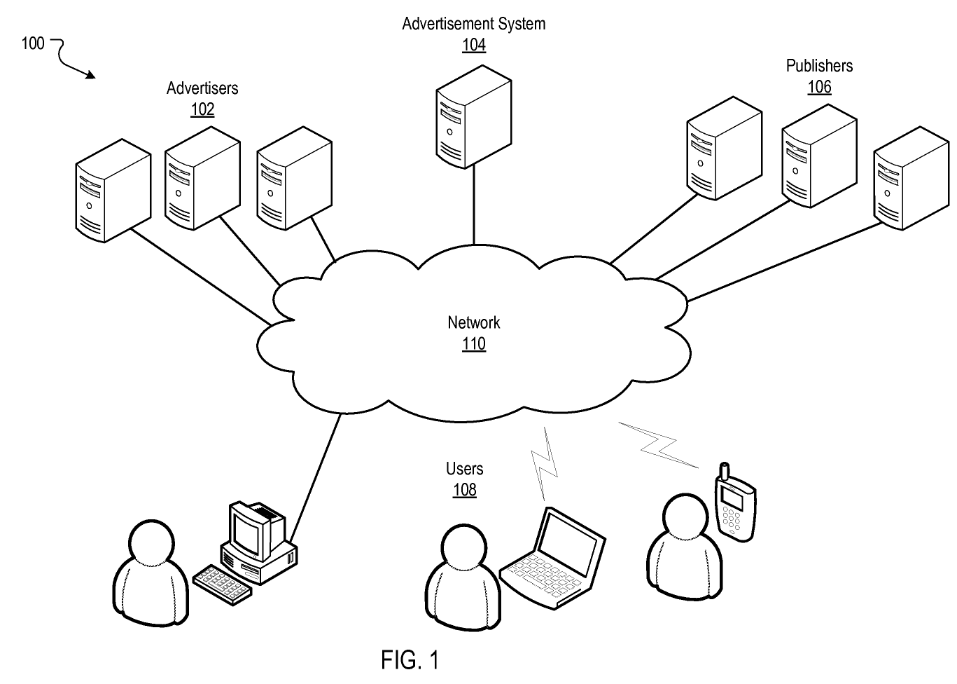

FIG. 1 is a block diagram of an example implementation of an online advertising system 100. In some implementations, one or more advertisers 102 can directly, or indirectly, enter, maintain, and track advertisement (“ad”) information in an advertisement system 104. The advertisements may be in the form of graphical advertisements, such as banner advertisements, text only advertisements, image advertisements, audio advertisements, video advertisements, advertisements combining one of more of any of such components, etc. The advertisements may also include embedded information, such as a links, meta-information, and/or machine executable instructions. One or more publishers 106 may submit requests for advertisements to the system 104. The system 104 responds by sending advertisements (e.g., when an associated publication is rendered) to the requesting publisher 106 (or a browser associated with a requesting user) for placement/co-location on one or more of the publisher's rendered web properties (e.g., websites and other network-distributed content). While reference is made to advertisements, other content items can be provided by the system 104.

Other entities, such as users 108 and the advertisers 102, can provide usage information to the system 104, such as, for example, whether or not a conversion or click-through related to an advertisement has occurred.

A click-through can occur, for example, when a user of a user device, selects or “clicks” on an advertisement. The click-through rate can be a performance metric that is obtained by dividing the number of users that clicked on the advertisement or a link associated with the advertisement by the number of times the advertisement was delivered. For example, if an advertisement is delivered 100 times, and three persons clicked on the advertisement, then the click-through rate for that advertisement is 3%.

A “conversion” occurs when a user, for example, consummates a transaction related to a previously served advertisement. What constitutes a conversion may vary from case to case and can be determined in a variety of ways.

This usage information can include measured or observed user behavior related to advertisements that have been served. The system 104 performs financial transactions, such as crediting the publishers 106 and charging the advertisers 102 based on the usage information.

A computer network 110, such as a local area network (LAN), wide area network (WAN), the Internet, or a combination thereof, connects the advertisers 102, the system 104, the publishers 106, and the users 108.

One example of a publisher 106 is a general content server that receives requests for content (e.g., articles, discussion threads, music, video, graphics, search results, web page listings, information feeds, etc.), and retrieves the requested content in response to the request. The content server may submit a request for advertisements to an advertisement server in the system 104. The advertisement request may include a number of advertisements desired. The advertisement request may also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the advertisements provided by the system 104. This combined content and advertisements can be sent to the user 108 that requested the content for presentation in a viewer (e.g., a browser or other content display system). The content server can transmit information about the advertisements back to the advertisement server, including information describing how, when, and/or where the advertisements are to be rendered (e.g., in HTML or JavaScript™).

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search service can submit a request for advertisements to the system 104. The request may include a number of advertisements desired. This number may depend on the search results, the amount of screen or page space occupied by the search results, the size and shape of the advertisements, etc. In some implementations, the number of desired advertisements will be from one to ten, or from three to five. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search service can combine the search results with one or more of the advertisements provided by the system 104. This combined information can then be forwarded to the user 108 that requested the content. The search results can be maintained as distinct from the advertisements, so as not to confuse the user between paid advertisements and presumably neutral search results.

Finally, the search service can transmit information about the advertisement and when, where, and/or how the advertisement was to be rendered back to the system 104.

As can be appreciated from the foregoing, the advertising management system 104 can serve publishers 106, such as content servers and search services. The system 104 permits serving of advertisements targeted to content (e.g., documents) served by content servers or in response to search queries provided by users. For example, a network or inter-network may include an advertisement server serving targeted advertisements in response to requests from a search service with advertisement spots for sale. Suppose that the inter-network is the World Wide Web. The search service crawls much or all of the content. Some of this content will include advertisement spots (also referred to as “inventory”) available. More specifically, one or more content servers may include one or more documents. Documents may include web pages, email, content, embedded information (e.g., embedded media), meta-information and machine executable instructions, and advertisement spots available. The advertisements inserted into advertisement spots in a document can vary each time the document is served or, alternatively, can have a static association with a given document.

In one implementation, the advertisement system 104 may include an auction process to select advertisements. Advertisers may be permitted to select, or bid, an amount the advertisers are willing to pay for each click of an advertisement, e.g., a cost-per-click amount an advertiser pays when, for example, a user clicks on an advertisement. In one implementation, the cost-per-click can include a maximum cost-per-click, e.g., the maximum amount the advertiser is willing to pay for each click of an advertisement. For example, advertisers A, B, and C all select, or bid, a maximum cost-per-click of $1.00, $0.60, and $0.60, respectively. The maximum amount advertiser A will pay for a click is $1.00, the maximum amount advertiser B will pay is $0.60, and the maximum amount advertiser C will pay is $0.60.

The position, or rank, of an advertisement, such as where the advertisement is displayed next to search results, can be a function of the cost-per-click multiplied by a click-through rate associated with the advertisement.

In one implementation, the rank of an advertisement can be determined by multiplying the maximum cost-per-click for the advertisement by the click-through rate of the advertisement. The advertisement can then be placed among other advertisements in order of increasing or decreasing rank. For example, suppose the click-through rate of advertisers A, B, and C are “10%,” “8%,” and “3%,” respectively. The rank of advertisements A, B, and C can be determined according to the max estimated cost-per-thousand impressions (eCPM) of each advertisement. The max estimated cost-per-thousand impressions can be calculated as follows:

A: max eCPM=CTR×maximum cost-per-click=0.10×$1.00.10=0.1

B: max eCPM=CTR×maximum cost-per-click=0.08×$0.60=0.048

C: max eCPM=CTR×maximum cost-per-click=0.03×$0.60=0.018

The advertisers can be ranked in decreasing order of max estimated cost-per-thousand impressions as follows:

1. A

2. B

3. C

In some implementations, an advertisement may not be promoted unless the advertisement meets a threshold. Promoting an advertisement can, in some implementations, include locating the advertisement in a more visible position. The advertisements can, for example, be placed above search results in response to a search query. In one implementation, promoting an advertisement includes presenting the advertisement to a user, where advertisements that are not promoted are not presented to the user. The advertisement can, for example, be promoted according to the following formula:

CTR*auction CPC>T

In one implementation, the auction cost-per-click is the price that is necessary to keep the advertisement's position above the next advertisement. To determine the auction cost-per-click, the system 104 can determine how much the advertiser in position 1 would have to pay to give them a rank equal to the advertiser in position 2. Then the system 104 adds a predetermined amount, e.g., $0.01, to this amount. An auction cost-per-click of an advertisement can be determined based the click-through rate of the advertisement and maximum estimated cost-per-thousand impressions of the advertisement below. To determine the auction cost-per-click, the system 104 can divide the maximum estimated cost-per-thousand impressions of the advertisement below the current advertisement by the click-through rate of the current advertisement. Then the system 104 adds a predetermined amount, e.g., $0.01, to this amount. The final amount is the auction CPC.

The last advertiser in the ranked list can pay a minimum cost-per-click to hold the position in the list. For example, suppose the minimum cost-per-click is $0.20. The auction cost-per-click of advertisers A, B, and C can be determined as follows:

A: (B's max eCPM/A's click-through rate)/1000=(0.048/0.1)=$0.48+$0.01=$0.49

B: (C's max eCPM/B's click-through rate)/1000=(0.018/0.08)=$0.23+$0.01=$0.24

C: minimum cost-per-click=$0.20

Therefore, A's auction cost-per-click is $0.49, B's auction cost-per-click is $0.24, and C's auction cost-per-click is $0.20.

If the threshold was 0.02, then whether the advertisements were promoted according to the above formula CTR*auction CPC>T can be determined as follows:

A: 0.1*$0.49=0.049>0.02

B: 0.08*$0.24=0.0192 not greater than 0.02

C: 0.03*$0.20=0.006 not greater than 0.02

Therefore, in this example, advertisement A would be the only advertisement promoted since it is the only advertisement that exceeds the threshold of 0.02. Thereafter, advertiser A is charged the auction cost-per-click amount of $0.49.

In some implementations, to maximize revenue, the advertisement system 104 can use a different formula to determine whether the threshold has been met as well to determine an actual cost-per-click charged for each advertisement.

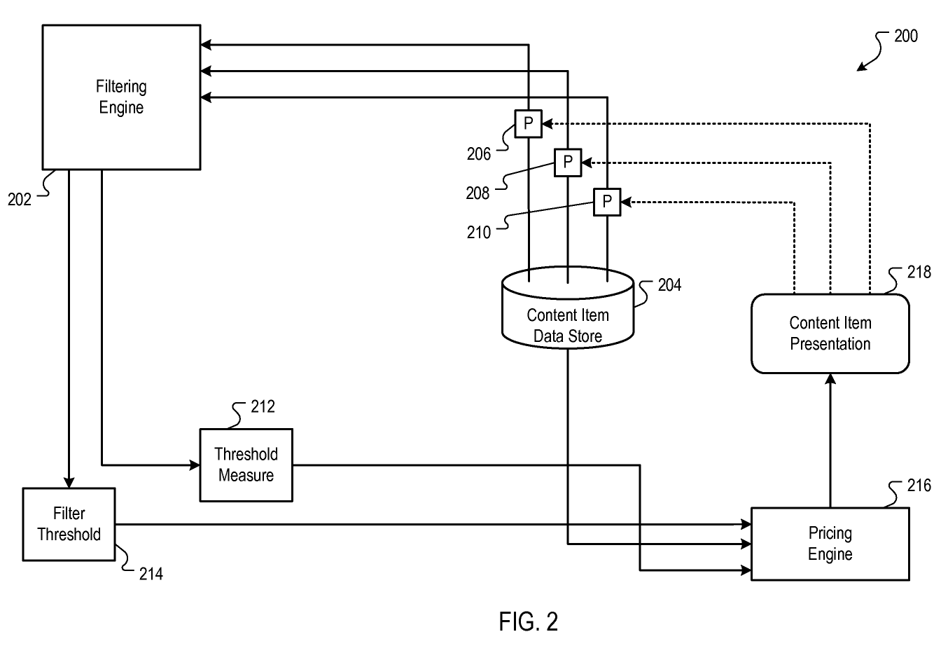

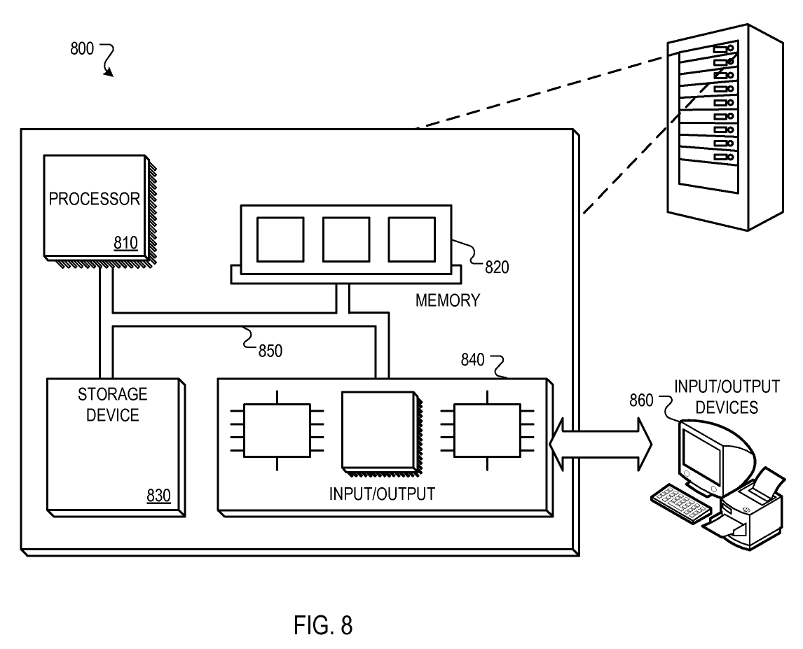

FIG. 2 is a block diagram of an example content filtering system 200. The content filtering system 200 can, for example, be implemented in a computer device or one or more computer devices connected through a network, e.g., a local area network (LAN) or a wide area network (WAN), such as the Internet. The content filtering system 200 can, for example be implemented in the advertisement system 104, which can be implemented in a computing system. The one or more computing devices can, for example, include memory devices storing processing instructions and processing devices for executing the processing instructions. An example computing system is shown and described with reference to FIG. 8. Other implementations, however, can also be used.

In addition to filtering the content items to define a subset of content items eligible to be presented in a presentation environment, the content filtering system 200 can determine an actual cost-per-click to associate with each of the content items.

The content filtering system 200 can, for example, filter the content items to select a subset of the content items that have been ranked according to the auction process. The subset can be selected based on parameters associated with respective advertisements, e.g. cost-per-click and/or the click-through rate of each advertisement. Only advertisements that are part of the selected subset can be displayed to a user in a presentation environment.

The content filtering system 200 can, for example, include a filtering engine 202 and a content item data store 204. In one implementation, the content item data store 204 can comprise a unitary data store, such as a hard drive. In another implementation, the content data store 204 can comprise a distributed data store, such as a storage system that is distributed over a network. Other implementations, however, can also be used.

In one implementation, the content data store 204 can store one or more advertisements. Each advertisement in the content data store 204 can be associated with one or more parameters 206, 208, and 210. Each of the parameters 206, 208, and 210 can be associated with performance metrics, e.g., click-through rates, conversions, auction metrics, cost-per-clicks, etc. In one implementation, the content filtering system 200 can monitor and/or evaluate performance data related to the content items in the content data store 204. For example, the performance of each advertisement in the content data store 204 can be evaluated based on a performance metric associated with the advertisement, such as a click-through rate, a conversion rate, or some other metric. In one implementation, the content filtering system 200 can also monitor and/or evaluate auction data related to the content items in the content data store 204. Each advertisement in the content data store 204 can be evaluated based on an auction metric associated with the advertisement, such as a cost-per-click.

In one implementation, the cost-per-click associated with an advertisement can be a maximum cost-per-click, an auction cost-per-click, or a reserve cost-per-click. The maximum cost-per-click, as described above, is the maximum amount an advertiser will pay for a click on their advertisement. The auction cost-per-click, as described above, is the price that is necessary to keep the advertisement's position above the next advertisement. The reserve cost-per-click is the minimum cost-per-click required for the advertisement to be promoted and displayed for a user.

Other performance metrics can also be used, such as dwell time at a landing page, etc. The performance metrics can, for example, be revenue related or non-revenue related. In another implementation, the performance metrics can be parsed according to time, e.g., the performance of a particular content item may be determined to be very high on weekends, moderate on weekday evenings, but very low on weekday mornings and afternoons, for example.

In one implementation, the filtering engine 202 can determine a threshold measure 212 for an advertisement. The threshold measure 212 can be used to determine whether the advertisement can be displayed (or promoted) to a user. The threshold measure 212 can be compared to a selected filter threshold 214 to determine whether the advertisement is selected as one of a subset of advertisements.

In one implementation, the threshold measure 212 can be determined based on the one or more parameters 206, 208, and 210 associated with the advertisement. A threshold measure 212 can, for example, be determined using any one of the parameters 206, 208, 210 alone, or in combination with other functions, e.g., an exponential function, and variables. The threshold measure 212 can, for example, be determined using the parameters click-through rate and cost-per-click.

In another implementation, the threshold measure 212 can be determined by raising a quality score to an exponential power and multiplying the quality score raised to an exponential power by a maximum cost-per click raised to an exponential power. For example, if the exponential values are “x” and “y,” the threshold measure 212 can be determined according to the formula:

T_advertisement=QS_advertisement\hat{0}x*max_{—}CPC_advertisement\hat{0}y

Where T_advertisement is the threshold measure, QS_advertisement is the quality score of the advertisement, and max_CPC_advertisement is the maximum cost-per-click of the advertisement.

A quality score can be the basis for measuring the quality and relevance of an advertisement and determining a minimum cost-per-click. The quality score can, for example, be determined by the advertisement's click-through rate, the relevance of the advertisement text, overall historical keyword performance, and the user experience on a landing page associated with the advertisement.

In one implementation, the quality score can be calculated according to the formula:

QS_advertisement=CTR_advertisement\hat{0}a*GoodClick_advertisement\hat{0}b

Where QS_advertisement is the quality score of the advertisement, CTR_advertisement is the click-through rate of the advertisement, and GoodClick_advertisement is a prediction of whether a user will like the site associated with the advertisement if the user clicks on the advertisement.

GoodClick_advertisement may be calculated, as described in co-pending U.S. application Ser. No. 10/321,064, entitled “Using estimated ad qualities for ad filtering, ranking and promotion” and incorporated by reference herein.

In another implementation, the threshold measure 212 can be determined according to the formula:

T_advertisement=CTR_advertisement\hat{0}x*max_{—}CPC_advertisement\hat{0}y

Where T_advertisement is the threshold measure, CTR_advertisement is the click-through rate of the advertisement, and max_CPC_advertisement is the maximum cost-per-click of the advertisement.

In one implementation, the filtering engine 202 can determine if the threshold measure 212 exceeds the filter threshold 214 and filter the advertisements based on the determination.

In one implementation, the filtering engine 202 can, for example, determine the filter threshold 214 and the exponential value x and y based on historical data associated with the advertisements, and by selecting the filter threshold 214 and the exponential values yielding, for example a desired or most promising simulation data. Historical data can, for example, include previous values of the parameters associated with the advertisements. For example, historical data can include previous click-through rates associated with the advertisements. An advertisement can be associated with one or more click-through rates based on previous performance. For example, the click-through rate of an advertisement can change and increase or decrease over time. Historical data can also include previous quality scores associated with the advertisements. An advertisement can be associated with one or more quality scores based on previous performance.

Historical data can also include, for example, previous cost-per-clicks associated with the advertisement. The cost-per-click of an advertisement can, for example, increase or decrease over time. An advertiser can, for example, decide whether to lower or increase the amount the advertiser would pay for a click on the advertisement.

Determining the filter threshold 214 and the exponential values based on historical data related to the advertisement can, for example, include generating simulation filter threshold values and simulation functional (e.g., exponential values for x and y). The filtering engine 202 can determine the filter threshold 214 and the exponential values based on historical data related to the advertisement by generating simulation data based on simulation filter threshold values and the simulation exponential values, and selecting the filter threshold 214 and the exponential values yielding the most promising/desirable simulation data. The filtering engine 202 can, for example, use historical data associated with an advertisement, such as previous click-through rates and cost-per-clicks, as well as simulation filter threshold values and simulation exponential values, to generate simulation data 216. The simulation filter threshold values can be used to simulate performance scenarios in which the threshold measure 212 is compared to the simulation filter threshold to determine if the simulated threshold measure 212 exceeds the simulation filter threshold, and generate expected revenue and quality estimates. An actual threshold value and exponential values x and y can be selected based on a maximized revenue value and/or maximized quality target.

For example, a training set of historical data related to the performance of advertisements that were not filtered can be utilized to generate simulation scenarios based on simulated filter thresholds and exponential values. The performance of the advertisements after filtering can be modeled to estimate a revenue or quality gain. For example, the changes in the probabilities of advertisements being selected in the absence of advertisements that were actually selected can be modeled; the changes in the probabilities of advertisements being selected in the presence of other advertisements that were not actually selected can be modeled; etc.

In one implementation, the filtering engine 202 can compare the simulation data to the historical data, and optimize the filter threshold 214 and the exponential values x and y based on the comparison. For example, the filtering engine 202 can perform iterative simulations to optimize the filter threshold based on the comparison. Optimizing the filter threshold can include, for example, adjusting the filter threshold 214 so that fewer or more advertisements are filtered. The iterative simulations can be utilized to estimate one or more of a revenue gain or a quality gain.

In one implementation, the value of the filter threshold 214 can be changed at any time. For example, the filter threshold can be changed weekly, monthly, bimonthly, etc. In one implementation, the value of the filter threshold 214 can change according to budget usage of advertisers. For example, advertisers can specify a budget to indicate the maximum amount of money to be spent on advertisements or campaigns for a certain amount of time. For example, a first advertiser may choose to pay a first amount per month for a campaign; a second advertiser may choose to pay a second amount per month for a campaign, etc.

If advertiser budgets related to advertisements that are not filtered according to the filter threshold 214 are depleted, the amount of eligible advertisements for display may likewise be depleted. Accordingly, the filtering engine 202 can, for example, adjust the filter threshold 214 in this to allow a larger number of advertisements to become eligible for display.

In one implementation, the filtering engine 202 can promote the advertisement if the threshold measure 212 of the advertisement exceeds the filter threshold 214. Promoting an advertisement allows the filtering engine 202 to display the advertisement in a content item presentation environment 222. An advertisement that does not have a threshold measure 212 that exceeds the filter threshold 214 may not be promoted, and will not be displayed in the environment 222.

In one implementation, the advertisement can be ranked according to the maximum estimated cost-per-thousand impressions of the advertisement after the advertisement is promoted. The maximum estimated cost-per-thousand impressions can be determined using the one or more parameters 206, 208, and 210. The maximum estimated cost-per-thousand impressions can, for example, be determined by multiplying a click-through rate associated with the advertisement by a maximum cost-per-click associated with the advertisement, as described above. In one implementation, this result can then be multiplied by 1000. The maximum estimated cost-per-thousand impressions can, for example, be compared to maximum estimated cost-per-thousand impressions of other advertisements that also have a threshold measure 212 that exceeded the filter threshold 214, and the advertisements can be ranked by the ranking engine 220 according to the maximum estimated cost-per-thousand impressions. The ranked advertisements can be shown in a content item presentation environment 222, e.g., a web browser page. The advertisements can be ranked by each advertisement's maximum estimated cost-per-thousand impressions in decreasing order. Actions taken by a user in the presentation environment 222 can affect one or more of the parameters 206, 208 and 210, and accordingly affect subsequent rankings or presentations.

In one implementation, the pricing engine 216 can determine an actual cost-per-click for the advertisement based on the one or more parameters 206, 208, and 210 and the filter threshold. The actual cost-per-click can be determined if the advertisement is promoted. The actual cost-per-click can, for example, be the amount the advertiser associated with the advertisement is charged once the advertisement is promoted.

In one implementation, determining the actual cost-per-click includes identifying the auction cost-per-click associated with the advertisement. The auction cost-per-click can be the price that is necessary to keep the advertisement's position above a next lower rated advertisement. To determine the auction cost-per-click, the pricing engine 216 can determine how much the advertiser in position 1 would have to pay to give them a rank equal to the advertiser in position 2. Then the pricing engine 216 adds a predetermined amount, e.g., $0.01 to this amount. The auction cost-per-click of an advertisement can, for example, be determined based the click-through rate of the advertisement and maximum estimated cost-per-thousand impressions of the advertisement below. To determine the auction cost-per-click, the pricing engine 216 can divide the maximum estimated cost-per-thousand impressions of the advertisement below the current advertisement by the click-through rate of the current advertisement and add a predetermined amount (e.g., $0.01 is added) to this number. The final amount is the auction cost-per-click.

In one implementation, after the maximum estimated cost-per-thousand impressions of the advertisement below the current advertisement is divided by the click-through rate of the current advertisement, this number is then divided by 1000. The pricing engine 216 can then add $0.01 to this amount. In one implementation, if no advertiser exists below the current advertiser, then the auction cost-per-click of the current advertiser is the minimum cost-per-click that is set by the pricing engine 216. In another implementation, the auction cost-per-click can be calculated for every advertisement, whether or not the advertisement is promoted. In one implementation, if the auction cost-per-click is lower than the minimum cost-per-click set by the pricing engine 216, the advertiser is charged the minimum cost-per-click.

In one implementation, determining the actual cost-per-click includes identifying the reserve cost-per-click associated with the advertisement. The reserve cost-per-click is a minimum amount required to promote an advertisement. The pricing engine 216 can calculate the reserve cost-per-click by dividing the filter threshold 214 by the click-through rate of the advertisement. Then the pricing engine 216 adds a second predetermined amount (e.g., $0.01) to this amount. This final amount is the reserve cost-per-click.

In one implementation, the pricing engine 216 can select the greater of the auction cost-per-click and the reserve cost-per-click as the actual cost-per-click for the advertisement. The advertiser 106 associated with the advertisement can be charged the greater of the auction cost-per-click and the reserve cost-per-click, e.g., the actual cost-per-click, every time the advertisement of the advertiser 106 is clicked on by a user, as will be described below.

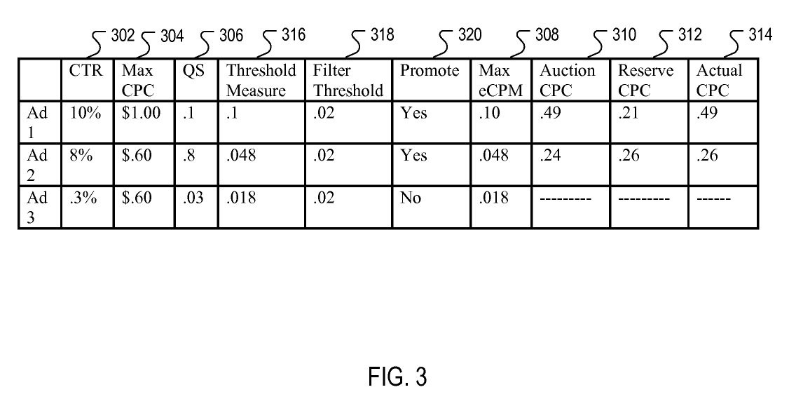

FIG. 3 is an example filtering and ranking table 300. The table 300 describes the filtering and pricing of advertisements AD1, AD2 and AD3, and is based one or more parameters, e.g., a click-through rate, a maximum cost-per-click, quality score, maximum estimated cost-per-thousand impressions, auction cost-per-click, a reserve cost-per-click, and an actual cost-per-click as indicated in the click-through rate column 302, the max CPC column 304, the QS column 306, the max eCPM column 308, the auction CPC column 310, the reserve CPC column 312, and the actual CPC column 314.

As shown in FIG. 3, the advertisements AD1, AD2, and AD3 have corresponding click-through rates of 10%, 8%, and 3% respectively, corresponding maximum cost-per-click rates of $1.00, $0.60, and $0.60, respectively, and corresponding quality scores of 0.1, 0.08, and 0.03. A threshold measure, as listed in the threshold measure column 316, can be determined for each of the advertisements AD1-AD3. The threshold measure can, for example, be determined based on the parameters quality score and maximum cost-per-click parameters, e.g., QS\hat{0}x*max_CPC\hat{0}y. In this example, x and y are “1.”

The filtering engine 202 can, for example, determine whether the threshold measure for each advertisement exceeds a filter threshold that is listed in a filter threshold column 318. Each of the threshold measures for AD1-AD3 can be compared against the filter threshold to determine which advertisements have threshold measures that exceed the filter threshold. In this example, the advertisements AD1 and AD2 have threshold measures, e.g., 0.1 (0.10\hat{0}1*1.00\hat{0}1) and 0.048 (0.08\hat{0}1*0.60\hat{0}1), that exceed the filter threshold of 0.02, and the advertisement AD3 has a threshold measure, e.g., 0.018 (0.03\hat{0}1*0.60\hat{0}1), that does not exceed the filter threshold of 0.02. Accordingly, the advertisements AD1 and AD2 are promoted, as indicated by the promote column 320.

In some implementations, the filtering engine 202 can rank the advertisements based on the one or more parameters. For example, the ranking engine 220 can rank all of the advertisements based on the maximum eCPM (CTR*max CPC), the values for which are shown in the max eCPM column 308. In this example, the quality score is the same as the click-through rate of each advertisement. The advertisements AD1-AD2 can be ranked accordingly. The eCPM of AD1 is 0.1 (0.10*1.00). The eCPM of AD2 is 0.048 (0.08*0.60). Therefore AD1 is ranked first since its eCPM, e.g., 0.1, is higher than the eCPM of AD2, e.g., 0.048. However, as the advertisement AD3 is filtered out of the final presentation process because it did not have a threshold measure that exceeded the filter threshold, only the advertisements AD1 and AD2 are ranked and presented to a user. The eCPM of AD3 can be calculated, however, because the eCPM is used to determine the auction cost-per-click for AD2, as described below. The eCPM of AD3 is 0.018 (0.03*0.60).

In some implementations, after the filtering engine 202 determines which advertisements have a threshold measure that exceeds the filter threshold and therefore get promoted, the pricing engine 216 can determine an actual cost-per-click of the advertisement based on the one or more parameters and the filter threshold. For example, the pricing engine 216 can calculate the auction cost-per-click, as listed in column 310, and the reserve cost-per-click, as listed in column 312, and select the higher of the two as the actual cost-per-click, as listed in column 314.

The pricing engine 216 can calculate the auction cost-per-click 310 of AD1 by, for example, dividing the eCPM of AD2 by the click-through rate of AD1. The pricing engine can then add a predetermined amount (e.g., $0.01) to calculate the auction CPC. The auction cost-per-click of AD1 is $0.49((0.048/0.1)+$0.01). The auction cost-per-click of AD2 can be calculated in the same manner. The auction cost-per-click of AD2 is $0.24((0.018/0.08)+$0.01).

The pricing engine 216 can determine the reserve cost-per-click by dividing the filter threshold by the click-through rate of the advertisement and adding a predetermined amount ($0.01). The reserve cost-per-click of AD1 is calculated as $0.21((0.02/0.1)+$0.01). The reserve cost-per-click of AD2 is calculated as $0.26((0.02/0.08)+$0.01).

In one implementation, the pricing engine 216 can select the greater of the auction cost-per-click and the reserve cost-per-click as the actual cost-per-click to charge the advertiser of each advertisement. In this example, for AD1, the auction cost-per-click, e.g., $0.49 is higher than the reserve cost-per-click, e.g., $0.21. Therefore, the actual cost-per-click for AD1 is $0.49, the auction cost-per-click. For AD2, the auction cost-per-click, e.g., $0.24 is not higher than the reserve cost-per-click, e.g., $0.26. Therefore, the actual cost-per-click of AD2 is $0.26, the reserve cost-per-click.

The filter threshold in the filter threshold column 318 may be adjusted in response to a trigger event. For example, a trigger event can be a time period, e.g., monthly; a trigger event can be falling below a revenue target, e.g., the advertising system does not realize a weekly revenue goal; a trigger event can be based on an availability of a minimum number of advertisements; or some other event.

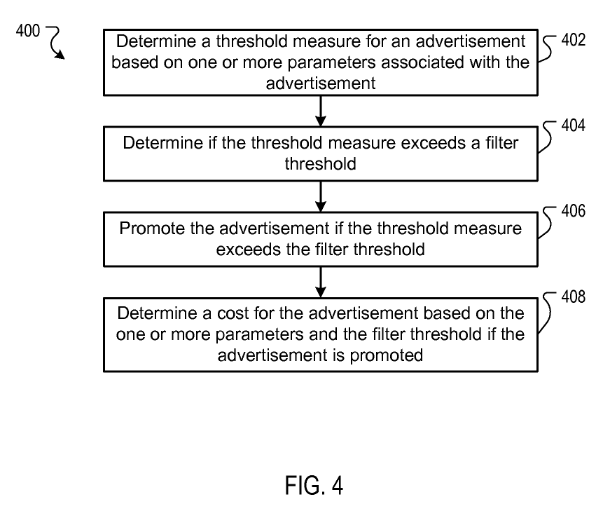

FIG. 4 is a flow diagram of an example process 400 for filtering and pricing an advertisement. The process 400 can, for example, be implemented in a system such as the content filtering system 200 of FIG. 2.

Stage 402 determines a threshold measure for an advertisement based on one or more parameters associated with the advertisement. For example, the filtering engine 202 can calculate a threshold measure for an advertisement based on one or more parameters associated with the advertisement, e.g., based on the calculation of QS \hat{0}x*max_CPC\hat{0}y. Stage 404 determines if the threshold measure exceeds a filter threshold. For example, the filtering engine 202 can determine if the threshold measure exceeds a filter threshold. Stage 406 promotes the advertisement if the threshold measure exceeds the filter threshold. For example, the filtering engine 220 can promote the advertisement if the threshold measure exceeds the filter threshold. Stage 408 determines an actual cost-per-click for the advertisement based on the one or more parameters and the filter threshold if the advertisement is promoted. For example, the pricing engine can determine an actual cost-per-click for the advertisement based on the one or more parameters and the filter threshold if the advertisement is promoted.

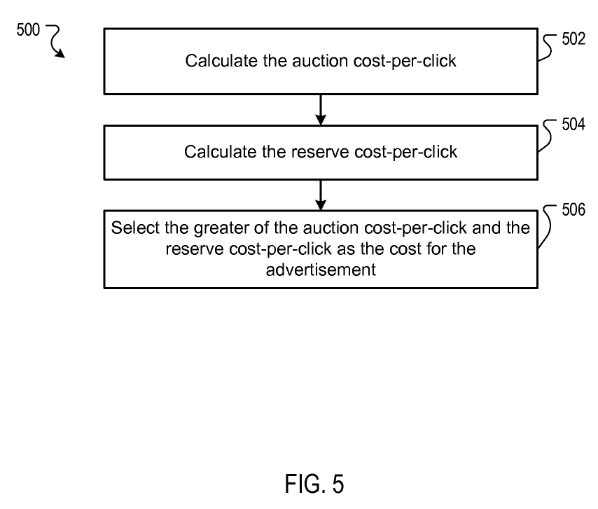

FIG. 5 is an example process 500 for determining an actual cost-per-click for an advertisement based on the one or more parameters if the advertisement is promoted. The process 500 can, for example, be implemented in a system such as the content filtering system 200 of FIG. 2.

Stage 502 calculates the auction cost-per-click. For example, the pricing engine 216 can calculate the auction cost-per-click. Stage 504 calculates the reserve cost-per-click. For example, the pricing engine 216 can calculate the reserve cost-per-click. Stage 506 selects the greater of the auction cost-per-click and the reserve cost-per-click as the actual cost-per-click for the advertisement. For example, the pricing engine 216 can select the greater of the auction cost-per-click and the reserve cost-per-click as the actual cost-per-click for the advertisement.

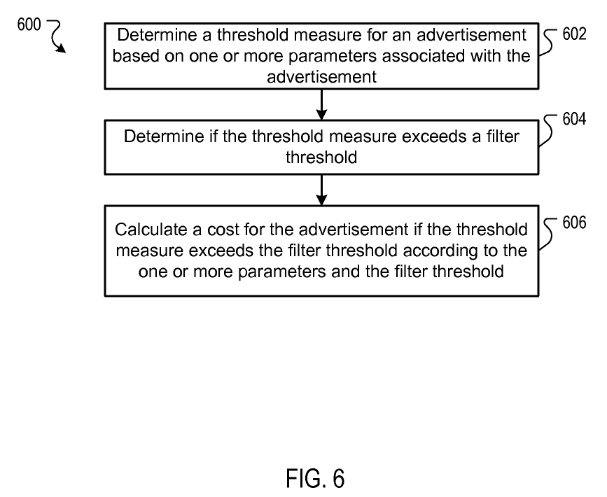

FIG. 6 is another example process 600 for filtering and pricing an advertisement. The process 600 can, for example, be implemented in a system such as the content filtering system 200 of FIG. 2 Stage 602 determines a threshold measure for an advertisement based on one or more parameters associated with the advertisement. For example, the filtering engine 202 can determine a threshold measure for an advertisement based on one or more parameters associated with the advertisement. Stage 604 determines if the threshold measure exceeds a filter threshold. For example, the filtering engine 202 can determine if the threshold measure exceeds a filter threshold. Stage 606 calculates an actual cost-per-click for the advertisement if the threshold measure exceeds the filter threshold according to the one or more parameters and the filter threshold. For example, the pricing engine 216 can calculate an actual cost-per-click for the advertisement if the threshold measure exceeds the filter threshold according to the one or more parameters and the filter threshold.

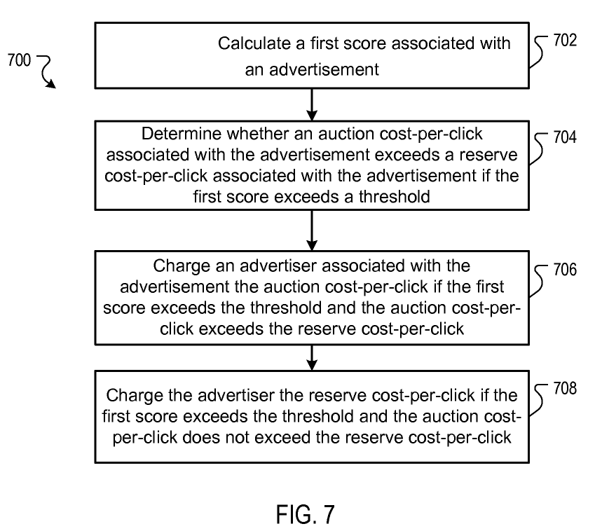

FIG. 7 is another example process 700 for filtering and pricing an advertisement. The process 700 can, for example, be implemented in a system such as the content filtering system 200 of FIG. 2.

Stage 702 calculates a first score associated with an advertisement. For example, the pricing engine 216 can calculate a first score associated with an advertisement. Stage 704 determines whether an auction cost-per-click associated with the advertisement exceeds a reserve cost-per-click associated with the advertisement (e.g., if the first score exceeds a threshold). For example, the pricing engine 216 can determine whether an auction cost-per-click associated with the advertisement exceeds a reserve cost-per-click associated with the advertisement if the first score exceeds a threshold. Stage 706 charges an advertiser associated with the advertisement the auction cost-per-click if the first score exceeds the threshold and the auction cost-per-click exceeds the reserve cost-per-click. For example, the pricing engine 216 can charge an advertiser associated with the advertisement the auction cost-per-click if the first score exceeds the threshold and the auction cost-per-click exceeds the reserve cost-per-click. Stage 708 charges the advertiser the reserve cost-per-click if the first score exceeds the threshold and the auction cost-per-click does not exceed the reserve cost-per-click. For example, the pricing engine 216 can charge the advertiser the reserve cost-per-click if the first score exceeds the threshold and the auction cost-per-click does not exceed the reserve cost-per-click.

FIG. 8 is block diagram of an example computer system 800. The system 800 includes a processor 810, a memory 820, a storage device 830, and an input/output device 840. Each of the components 810, 820, 830, and 840 can, for example, be interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can, for example, include a hard disk device, an optical disk device, or some other large capacity storage device.

The input/output device 840 provides input/output operations for the system 800. In one implementation, the input/output device 840 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 860. Other implementations, however, can also be used, such as mobile computing devices, mobile communication devices, set-top box television client devices, etc.

Although the above description refers to a content item such as an advertisement, content items such as video and/or audio files, web pages for particular subjects, news articles, etc. can also be used. For example, if a user clicks on a video file, then the owner or publisher of the video file can also generate revenue every time a user clicks on the video file. A threshold measure can also be determined for the video file according to one or more parameters associated with the video file, e.g., a click-through rate and/or a cost-per-click of the video file.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A method, comprising:
determining a threshold measure for an advertisement based on one or more parameters associated with the advertisement;
determining if the threshold measure exceeds a filter threshold;
promoting the advertisement if the threshold measure exceeds the filter threshold; and
determining an actual cost-per-click for the advertisement based on the one or more parameters and the filter threshold if the advertisement is promoted.

2. The method of claim 1, wherein the one or more parameters are associated with performance metrics or auction metrics.

3. The method of claim 1, wherein at least one parameter is a quality score.

4. The method of claim 3, wherein at least one parameter is a cost-per-click.

5. The method of claim 4, wherein the cost-per-click is one of a maximum cost-per-click, an auction cost-per-click, and a reserve cost-per-click.

6. The method of claim 5, wherein the threshold measure is based on a product of the maximum cost-per-click raised to a first exponential power and the quality score raised to a second exponential power.

7. The method of claim 1, wherein determining an actual cost-per-click for the advertisement based on the one or more parameters if the advertisement is promoted comprises:
Identifying the auction cost-per-click;
identifying the reserve cost-per-click; and
selecting the greater of the auction cost-per-click and the reserve cost-per-click as the actual cost-per-click for the advertisement.

8. The method of claim 7, wherein the reserve cost-per-click is based on a minimum cost-per-click required to exceed the filter threshold.

9. A method, comprising:
determining a threshold measure for an advertisement based on one or more parameters associated with the advertisement;
determining if the threshold measure exceeds a filter threshold; and
calculating an actual cost-per-click for the advertisement if the threshold measure exceeds the filter threshold according to the one or more parameters and the filter threshold.

10. The method of claim 9, wherein the one or more parameters are associated with performance metrics and auction metrics.

11. The method of claim 9, wherein at least one parameter is a quality score.

12. The method of claim 11, wherein at least one parameter is a cost-per-click.

13. The method of claim 12, wherein the cost-per-click is one of a maximum cost-per-click, an auction cost-per-click and a reserve cost-per-click.

14. The method of claim 13, wherein determining a threshold measure for an advertisement based on one or more parameters associated with the advertisement comprises:
calculating the threshold measure based on the product of the maximum cost-per-click raised to a first exponential power and the quality score raised to a second exponential power; and
promoting the advertisement if the threshold measure exceeds the filter threshold.

15. The method of claim 13, wherein calculating an actual cost-per-click for the advertisement if the threshold measure exceeds the filter threshold according to the one or more parameters comprises:
identifying the auction cost-per-click;
identifying the reserve cost-per-click; and
selecting the greater of the auction cost-per-click and the reserve cost-per-click as the actual cost-per-click for the advertisement.

16. The method of claim 15, wherein the reserve cost-per-click is based on a minimum cost-per-click required to exceed the filter threshold.

17. A method, comprising:
calculating a first score associated with an advertisement;
determining whether an auction cost-per-click associated with the advertisement exceeds a reserve cost-per-click associated with the advertisement if the first score exceeds a threshold;
charging an advertiser associated with the advertisement the auction cost-per-click if the first score exceeds the threshold and the auction cost-per-click exceeds the reserve cost-per-click; and
charging the advertiser the reserve cost-per-click if the first score exceeds the threshold and the auction cost-per-click does not exceed the reserve cost-per-click.

18. The method of claim 17, wherein the first score is based one or more parameters associated with the advertisement.

19. The method of claim 18, wherein at least one parameter is a quality score.

20. The method of claim 19, wherein at least one parameter is a cost-per-click.

21. The method of claim 20, wherein the cost-per-click is one of a maximum cost-per-click, an auction cost-per-click, and a reserve cost-per-click.

22. The method of claim 20, wherein calculating a first score associated with an advertisement comprises:
multiplying the maximum cost-per-click raised to a first exponential power and the quality score raised to a second exponential power.

23. The method of claim 21, wherein determining whether an auction cost-per-click associated with the advertisement exceeds a reserve cost-per-click associated with the advertisement if the first score exceeds a threshold comprises:
identifying the auction cost-per click based on the one or more parameters; and
identifying the reserve cost-per click based on the one or more parameters.

24. A system, comprising:
a threshold engine that determines a threshold measure for an advertisement based on one or more parameters associated with the advertisement, and determines if the threshold measure exceeds a filter threshold; and
a pricing engine that calculates an actual cost-per-click for the advertisement if the threshold measure exceeds the filter threshold according to the one or more parameters.

25. The system of claim 24, wherein the one or more parameters are associated with performance metrics and auction metrics.

26. The system of claim 25, wherein at least one parameter is a quality score.

27. The system of claim 26, wherein at least one parameter is a cost-per-click.

28. The system of claim 27, wherein the cost-per-click is one of a maximum cost-per-click, an auction cost-per-click and a reserve cost-per-click.

29. The system of claim 28, wherein the threshold engine:
calculates the threshold measure based on the product of the maximum cost-per-click raised to a first exponential power and the quality score raised to a second exponential power, and promotes the advertisements if the threshold measure exceeds the filter threshold.

30. A system, comprising:
means for determining a threshold measure for an advertisement based on one or more parameters associated with the advertisement;
means for determining if the threshold measure exceeds a filter threshold;
means for promoting the advertisement if the threshold measure exceeds the filter threshold; and
means for determining an actual cost-per-click for the advertisement based on the one or more parameters if the advertisement is promoted.
